(19) United States
(12) Patent Application Publication
(10) Pub. No.: US 2013/0260187 A1
(43) Pub. Date: Oct. 3, 2013

(54) REPLENISHABLE DOWNHOLE BATTERY

(71) Applicant: Kuo-Chiang Chen, Sugar Land, TX (US)

(72) Inventor: Kuo-Chiang Chen, Sugar Land, TX (US)

(73) Assignee: SCHLUMBERGER TECHNOLOGY CORPORATION, Sugar Land, TX (US)

(21) Appl. No.: 13/431,581

(22) Filed: Mar. 27, 2012

(51) Int. Cl. H01M 10/42; H01M 2/36; H01M 4/38

(52) U.S. Cl. 429/50; 429/105; 429/72; 429/81

(57) ABSTRACT

A battery for downhole use configured for fluid-based replenishment. The battery may include separate anode and cathode fluid tanks which may be refilled at various times throughout the life of the well. Upon coupling of a replenishment tool to the battery, it may be fully replenished in a matter of minutes. Further, the nature of the fluid tanks allows for decreased battery bulk in even as increase power and life are afforded due to overall tank volume. Thus, with minimal total intervention time, extended life and replenishable character may be achieved for a battery well suited for use in downhole environments.

### BACKGROUND

Exploring, drilling and completing hydrocarbon and other wells are generally complicated, time consuming and ultimately very expensive endeavors. In recognition of these expenses, added emphasis has been placed on efficiencies associated with well completions and maintenance over the life of the well. Over the years, ever increasing well depths and sophisticated architecture have made reductions in time and effort spent in completions and maintenance operations of even greater focus.

In terms of architecture, a well often includes a variety of lateral legs emerging from a main bore. For example, the terminal end of a cased well often extends into an open-hole region branching out into multiple lateral legs providing reservoir access. Of course, such open-hole lateral legs are also often found extending from other regions of the main bore as well. This type of architecture may enhance access to the reservoir, for example, where the reservoir is substantially compartmentalized. Regardless, such open-hole lateral leg sections often present their own particular challenges when it comes to completions installation and maintenance.

Similarly, another layer of well architecture sophistication may be provided through zonal isolation at various well locations. So, for example, the well may be effectively divided into different perforated production zones or regions based on overall well depth, lateral leg location or other factors. Regardless, production tubing may traverse the well through the various zones which are in turn annularly isolated from one another by packers or other isolating features. Thus, production from any particular zone may be regulated based on whether or not fluid access to the production tubing is provided at the zone.

Depending on the nature of the zonal isolation and hardware, the noted production at any given zone may be selectively determined. For example, sliding sleeves may be provided at the production tubing of each zone. Thus, production from the zone may be altered over the life of the well as the production profile changes. Indeed, this same type of concept may be employed with sliding sleeves located directly at perforated casing regions even without the use of packer-based zonal isolation or separate production tubing.

To avoid running a separate costly intervention dedicated to opening and closing sliding sleeves as described above, a dedicated power source such as a lithium ion battery may be positioned downhole as part of the permanently installed hardware. Thus, an operator may transmit a signal through the well from the oilfield surface so as to direct opening and closing of such sliding sleeves. Indeed, this same concept may be employed for a host of different downhole maneuvers set to take place over the life of the well. For example, downhole flow-control, data acquisitions, actuator triggering and a host of other maneuvers may be powered by a downhole permanently installed battery configured for use over a potentially extended period of time.

Unfortunately, current downhole battery life is relatively limited. For example, a conventional downhole lithium ion battery capable of such use is unlikely to survive for a period exceeding about 3-5 years in the well. Thus, such batteries may be largely ineffective as a power source for intelligent production, where parameters of fluid uptake from various well regions is sought to be modified over the more extended life of the well. More specifically, intelligent production that involves sliding a sleeve open or closed ten years into the life of the well will most likely require a shut down in well operations followed by an interventional application directed at the sleeve.

Efforts to extend the life of the battery may be undertaken. However, basic physics in terms of the conventional cathode/anode structural relationship render diminishing returns for such efforts, particularly in the downhole environment. For example, the relationship between power storage and density of these components is such that significant increases in size may yield slightly moderate increases in battery life. Further, the size increase results in a package of substantial bulk that may not be tailored down to narrower profiles due to geometric requirements of the noted cathode/anode component relationship. This may be particularly problematic in the limited space of the downhole environment where any increase in bulk creates added challenges.

In theory, however, drawbacks associated with limited battery life may alternatively be addressed by battery replacement and/or recharging. That is, as opposed to waiting to run a dedicated intervention to shift a sleeve open or closed at a potentially inopportune time, a battery change-out or recharge may be attempted at another time. For example, a change-out or recharge may be performed in conjunction with other downhole interventions undertaken throughout the life of the well. Thus, dedicated battery power for performing certain downhole applications may be supplied at the outset of hardware installations and re-supplied whenever any subsequent intervention is undertaken.

Unfortunately, battery change-out and/or recharge is largely impractical in the downhole environment. For example, due to limited space, a battery change-out would require an intervention that employs advanced robotics or other currently unavailable change-out system. Similarly, setting aside the added expense of rechargeable batteries, the recharge itself, through a hard-wired, contact based coupling tool, would likely take several hours to a day's worth of time to complete. Therefore, as a practical matter, operators are generally left a downhole battery of limited life that is later replaced by costly and untimely interventional applications dedicated to performing tasks no longer powered by the now dead battery.

### SUMMARY

A downhole battery is provided for substantially permanent placement at a location in a well. The battery includes separate refillable anode and cathode fluid tanks along with a reaction chamber. The reaction chamber is in fluid communication with the tanks and configured to supply power for a downhole application in the well. In one method, a battery media tool is delivered to the location of the battery and utilized in replacing the anode and cathode fluid. Of course, this summary is provided to introduce a selection of concepts that are further described below and is not intended as an aid in limiting the scope of the claimed subject matter.

### BRIEF DESCRIPTION OF THE DRAWINGS

FIG. 1 is a side sectional view of an embodiment of a downhole replenishable battery assembly.

FIG. 2 is an overview of an oilfield with a well accommodating multiple of the battery assemblies of FIG. 1.

FIG. 3 is a side partially sectional view of an embodiment of a battery replenishment tool for coupling to the battery of FIG. 1.

FIG. 4 is an enlarged view of the tool of FIG. 3 revealing wet-mate flow path coupling for fluid replenishment of the battery of FIG. 1.

FIG. 5 is a flow-chart summarizing an embodiment of employing a downhole replenishable battery assembly.

### DETAILED DESCRIPTION

Embodiments are described with reference to certain downhole architecture and applications. For example, embodiments herein are detailed with reference to a downhole architecture and assembly that allow for zonally isolated production. Indeed, the production is dynamic in that downhole power is provided on a near permanent basis such that a changing production profile over time may be responsively addressed. That is, sliding sleeves in different downhole isolated zones may be shifted open or closed depending on the nature of the changing production profile. However, such power requirements may be met in a manner capable of addressing a variety of other downhole applications. For example, long term sensors, electrical submersible pumps and any number of valve or other actuators may be powered by embodiments of downhole replinishable batteries as detailed herein. Regardless, embodiments described herein include a downhole replenishable battery that utilizes separate fluidly refillable anode and cathode tanks adjacent a reaction chamber. Thus, downhole power requirements may be met in a manner less constrained by conventional anode cathode architectural limitations.

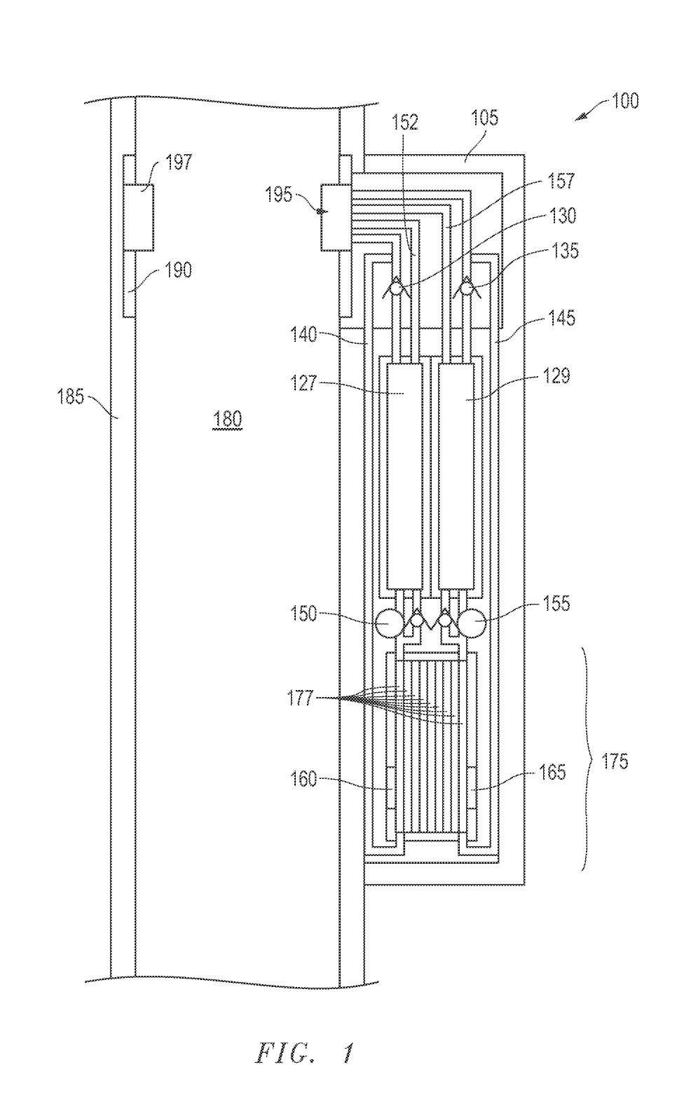

Referring now to FIG. 1, a side sectional view of an embodiment of a downhole replenishable battery assembly 100 is shown. The assembly 100 includes a battery 105 with separate anode 129 and cathode 127 fluid tanks. As detailed further below, separate anode and cathode fluids may be circulated in and out of the tanks 127, 129. Thus, an adjacent reaction chamber 175 may be supplied for obtaining electrical output from membrane segregated voids 177. Similarly, fluid spent in the process of such electrical generation may be circulated back to the tanks 127, 129 from the chamber 175 for later replenishment as also detailed further below.

The battery 105 is shown incorporated into a wall of downhole production tubing 185. As such, applications involving the tubing 185 or other adjacent well architecture may be powered by the battery 105. However, the battery 105 may be located in a variety of different downhole locations, whether incorporated with tubing or other types of hardware.

Once more, the architecture of the battery 105 itself may take a variety of different forms. That is, due to the fluidly circulating and replenishable nature of the battery 105, the dimensions of the reaction chamber 175 need not be structurally tied to the size of the noted tanks 127, 129. In fact, the tanks 127, 129 may be increased or elongated to any practical volumetric size without effect on the dimensions of the chamber 175. Thus, to a large extent, the overall shape of the battery 105 may be largely determined irrespective of power requirements or intended life expectancy.

With a greater degree of morphological flexibility available, operators may more freely configure the battery 105 with downhole placement and positioning in mind. Stated another way, as energy requirements increase, tanks 127, 129 may be elongated without a commensurate requirement of increasing the overall bulk of the reaction chamber 175. The fluid replenishment nature of the battery 105 affords more streamlined, lower profile morphologies, particularly advantageous for increased energy requirements in downhole environments.

Continuing with reference to FIG. 1, the noted circulation of fluids within the battery 105 is driven by pumps 150, 155 located in fluid communication with the tanks 127, 129 and the reaction chamber 175. More specifically, an anode pump 155 may be utilized to direct fluid from the anode tank 129 into certain membrane segregated voids 177 of the reaction chamber 175. Similarly, a cathode pump 150 may be utilized to direct fluid from the cathode tank 127 into other segregated voids 177 of the chamber 175. Further, this pump-assisted fluid direction ultimately results in voids 177 of alternating fluid types, an adjacently repeating fluid sandwich of anode, then cathode, then anode fluid material. In this manner, enhanced surface area interfacing is provided for electrically generating fluid reaction between the different anode and cathode fluids. This is achieved in a manner that also allows for the morphological advantages of the battery 105 as noted above.

Positive 160 and negative 165 charge plates may be coupled to the chamber 175 as a manner by which to take electrical advantage of the above indicated reactions. Once more, spent cathode and anode fluid may continue circulation through return lines 140, 145, respectively. In the embodiment shown, check valves 130, 135 are provided so as to govern the return of spent fluid from the lines 140, 145. That is, such fluid may be returned to the tanks 129, 127 or directed toward a sealable outlet 195 as detailed further below. Further, new fluids may be delivered to replenish the tanks 127, 129 via delivery lines 152, 157 as also detailed further below.

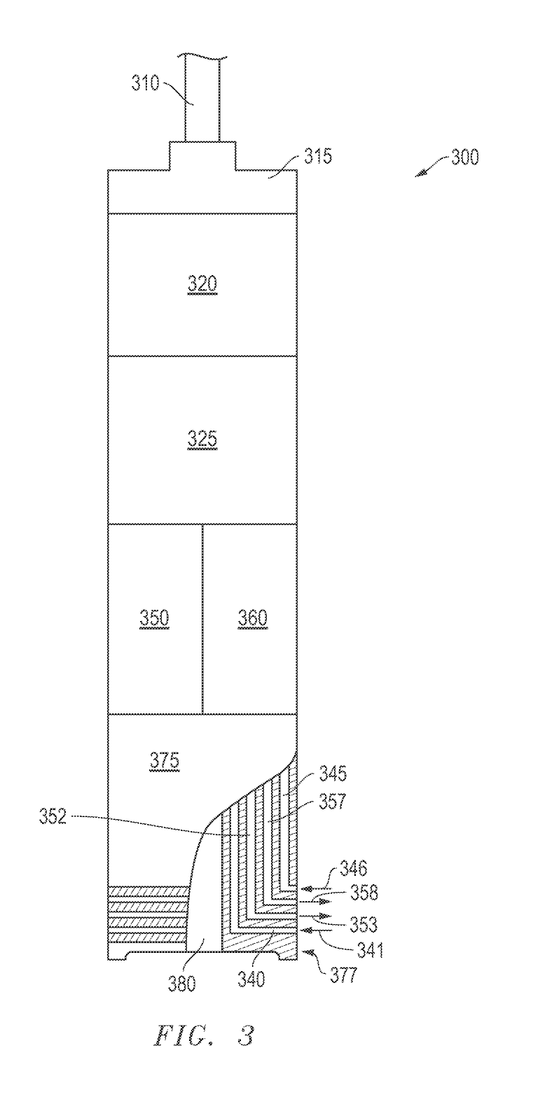

Continuing with reference to FIG. 1, with added reference to FIG. 3, access to the sealable outlet 195 may be governed by a shiftable seal 197 disposed at a recess 190 of the tubing 185. Thus, as also detailed further below, a battery replenishment tool 300 may be delivered through the channel 180 of the tubing 185 for shifting open of the seal 197 and circulating out spent fluids and delivering new fluids to the assembly 100.

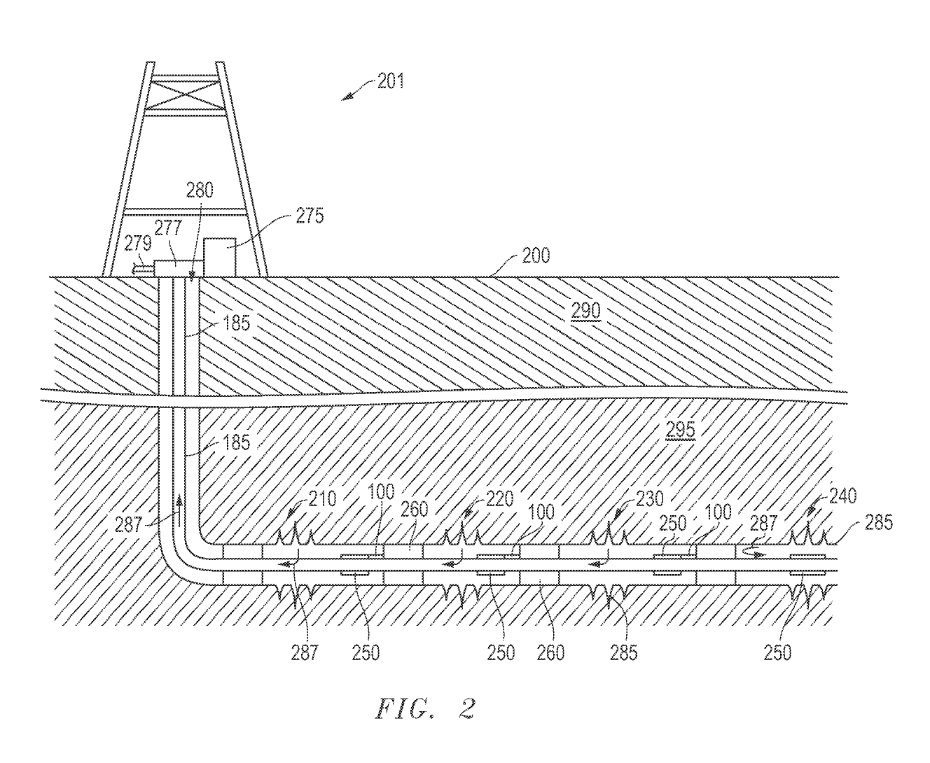

Referring now to FIG. 2, an overview of an oilfield 200 is shown with a well 280 accommodating multiple battery assemblies 100 of the FIG. 1 variety. In the embodiment shown, the battery assemblies 100 are utilized for opening and closing sliding sleeves 250 of the production tubing 185 in various isolated zones of the well 280. That is, power for opening and closing the sliding sleeves 250 is independently provided at each isolated zone as a manner of governing production, for example, as the production profile of the well 280 changes over time. This manner of utilizing the assemblies 100 to provide independent power within each isolated zone avoids the need for running a power cable or interventional application from surface so as to shift each sleeve 250. Of course, power supply advantages afforded by the assemblies 100 may be available for any number of downhole actuations, monitoring or other applications as well.

Continuing with reference to FIG. 2, the exemplary downhole architecture and techniques for taking advantage of replenishable battery assemblies 100 is described in further detail. Namely, the production tubing 185 and well 280 traverse various formation layers 290, 295 in reaching a host of production regions 210, 220, 230, 240. In the embodiment shown, these regions 210, 220, 230, 240 each include perforations 285 into the adjacent formation 295 as a manner of enhancing hydrocarbon production 287 therefrom.

While the production tubing 185 traverses the entire well 280, zonal isolation is provided by packers 260, disposed in the annulus about the tubing 185 for defining each region 210, 220, 230, 240. Thus, production into the tubing 285 may be independently governed at each region 210, 220, 230, 240. More specifically, the position of a sleeve 250 disposed at the production tubing 185 of each region 210, 220, 230, 240 may be used to determine whether or not the uptake of fluid production 287 takes place at the given region 210, 220, 230, 240. So, for example, in the embodiment depicted, fluid production 287 into the tubing 185 is prevented from taking place in the most terminal region 240 but allowed to take place in each of the others 210, 220, 230. This is due to the closed position of the sleeve 250 in the terminal region 240, for example, in response to water or other undesirable production thereat.

The sleeve positioning for governing production as detailed above may be powered by the battery assemblies 100 of each region 210, 220, 230, 240. Once more, these assemblies 100 may be utilized for powering a whole range of additional or different applications. For example, in one embodiment, sensors associated with the downhole hardware may acquire region specific data such as pressure, temperature, flow and other profile information. The acquisition, storage, processing and/or relay of such data to surface equipment 201 may be powered by the available battery assemblies 100.

Continuing with reference to FIG. 2, a control unit 275 is shown disposed at the oilfield surface 200 adjacent the well head 277. The unit 275 may be utilized for directing a host of downhole applications, perhaps even including the region specific opening and closing of the sleeves 250 as detailed above. Thus, the character of production fluid uptake 287 to the production line 279 may be ensured and/or enhanced over time, as the profile of the well 280 changes.

Referring now to FIG. 3, with added reference to FIG. 1, a side partially sectional view of an embodiment of a battery replenishment tool 300 is shown. The tool 300 is configured for physically coupling to the battery assembly 100 so as to circulate new cathode 353 and anode 358 fluids into the battery tanks 129, 127. Similarly, spent cathode 341 and anode 346 fluids may be simultaneously recovered from the assembly 100. Thus, a true replenishment of battery capacity may be provided.

With added reference to FIG. 2, the tool 300 is shown secured to coiled tubing 310 via a conventional coupling 315. Thus, a suitable manner for delivery of the tool 300 to downhole locations in a horizontal section of a well 280 may be provided. In the coiled tubing embodiment shown, the tool 300 includes a central passage 380 to allow for the other, possibly unrelated, fluid-based applications to also take place during battery replenishment as described below. Of course, in other embodiments, other types of conveyances may be utilized such as wireline or slickline, particularly where the well 280 is vertical in nature

Continuing with reference to FIG. 3 and added reference to FIG. 1, the tool 300 is made up of various sections between the noted coupling 315 and the mating section 375 of the tool 300. Namely, a tool power source 320 and pump 325 are provided to drive the above noted circulation. Of course, given the temporary interventional nature of the tool 300, the power source 320 may not necessarily be rechargeable or ‘replenishable’ as detailed herein. Indeed, a conventional lithium ion battery or other suitable downhole battery may suffice.

Additionally, mobile containers 350, 360 filled with new cathode 353 and anode 358 fluids are incorporated into the tool 300. In fact, the spent fluids 341, 346 may be drawn into the containers 350, 360 via tool intake lines 340, 345 in conjunction with the same circulation that delivers the new fluids 353, 358 to the assembly 100 via output lines 352, 357. With added reference to FIG. 1, this circulation takes place upon the shifting open of the seal 197 by a shifting extension 377 of the tool 300.

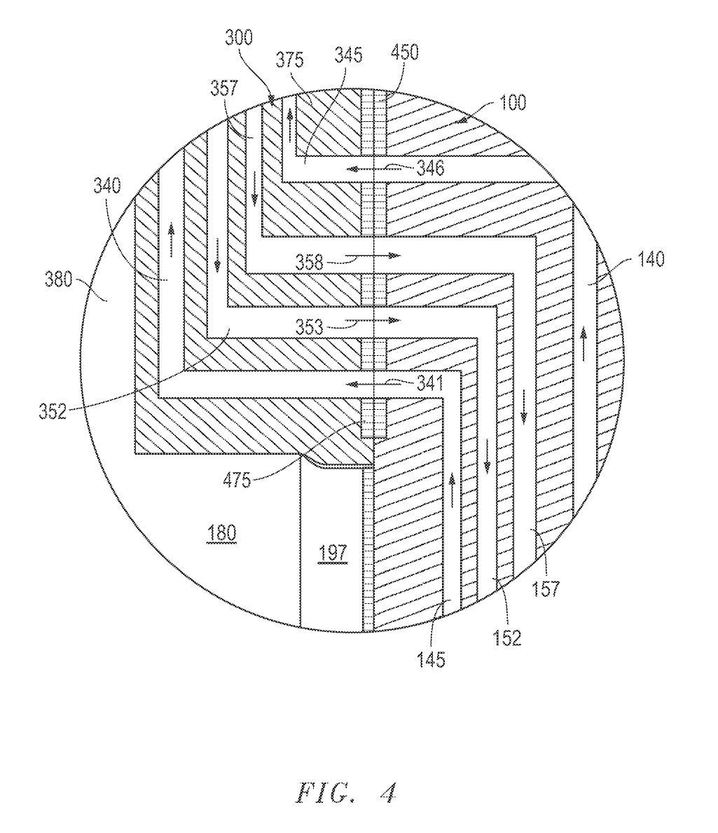

A closer examination of this circulation and the ‘wet’ mating of the tool 300 to the assembly 100 is described and depicted with reference to the enlarged view of FIG. 4 detailed below. Once more, the manner and rates of circulation, types of materials constituting the anode 346, 358 and cathode 341, 353 fluids and other battery-specific details may be akin to those described in Semi-Solid Lithium Rechargeable Flow Battery, Duduta et al., Advanced Energy Materials Vol. 1, 2011, incorporated by reference herein in its entirety.

Referring now to FIG. 4, an enlarged view of the tool 300 is shown revealing wet-mate flow path coupling for fluid replenishment of the battery assembly 100. More specifically, coupling of the tool 300 and assembly 100 is initiated by the shifting open of the seal 197 and the alignment of intake 340, 345 and return 140, 145 lines with one another. Similarly, the output 352, 357 and delivery 152, 157 lines are aligned with one another. This mating for the described circulation may take place with assembly 450 and tool 475 seals aligning and adjacently defining flow paths for each line connection.

With the above noted alignment achieved, spent cathode 341 and anode fluids 346 may be routed out of the assembly 100 and into the mating section 375 of the tool 300 as alluded to above. As also indicated above, this circulation may also include the simultaneous delivery of new cathode 353 and anode 358 fluids from containers 350, 360 of the tool 300 to the assembly 100 (see FIG. 3).

Continuing with reference to FIG. 4, the circulating anode fluids 346, 358 may include anode particles suspended in electrolyte whereas the circulating cathode fluids 341, 353 accordingly include cathode particles suspended in electrolyte. Thus, the assembly 100 may be referred to as a semi-solid flow battery assembly 100. More specifically, in one embodiment, the cathode fluids 341, 353 include a lithium nickel manganese oxide or other suitable lithium-based material. Further, the anode fluids 346, 358 may include a lithium titanium oxide or other suitable lithium-based material. In still other embodiments, a variety of different types of cathode and anode materials may be suspended in electrolyte, perhaps as powders providing solids content ranging between about 40-60% depending on the nature of the formulation. Of course, other formulation percentages may also be utilized.

The described circulation of fluids 341, 346, 353, 358 may proceed at any number of practical replenishment rates. For example, in one embodiment, a replenishment cycling in and out of the various new 353, 358 and spent 341, 346 fluids may take place at between about 10 to 30 ml per minute. Thus, depending on the particular size of the battery tanks 127, 129, the overall duration of replenishment is likely to take place in well under an hour, likely over the course of a matter of minutes. This is in sharp contrast to conventional hard-wire contact based, electrical battery recharge, which may take hours to achieve in circumstances where the battery is to provide any substantial degree of power. Therefore, in the context of a downhole environment, where reduction in intervention time may be of substantial benefit, replenishment as described may be particularly advantageous.

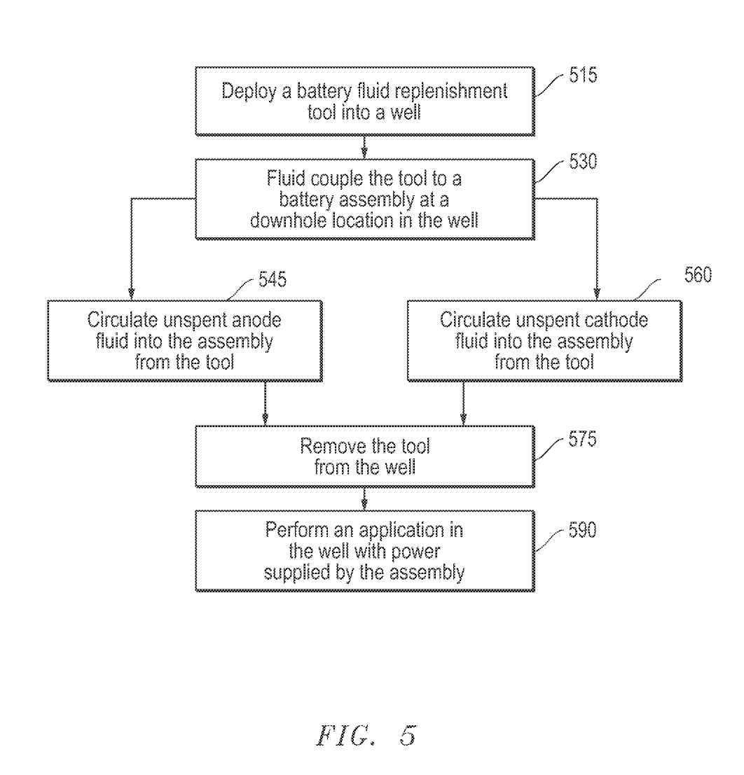

Referring now to FIG. 5, a flow-chart summarizing an embodiment of employing a downhole replenishable battery assembly is depicted. Namely, the battery assembly may be disposed at a downhole well location on a near permanent basis to provide power for any number of downhole applications as detailed above. However, as power is drained over time, a battery fluid replenishment tool may be deployed into the well as indicated at 515. Upon advancement to the assembly, the tool may be fluidly coupled thereto as noted at 530. Thus, new or ‘unspent’ anode and cathode fluids may be circulated into the assembly from the tool (see 545, 560). Indeed, at this same time, the spent anode and cathode fluids may be circulated out of the assembly, for example, back into the tool for removal from the well.

With the battery assembly replenished, the tool, along with recovered spent fluids, may be withdrawn from the well as indicated at 575. Thus, as noted at 590, power for subsequent well application may again be available via the battery assembly.

Embodiments described hereinabove include an assembly and techniques for addressing limited battery life in a downhole environment. The assembly and replenishment techniques detailed allow for renewal of battery functionality in a manner that does not require a complete battery hardware change-out or long-term recharge on the scale of several hours. Indeed, the detailed replenishment is even flexible enough in nature to allow for intervention to occur at a time of operator choosing, for example, in conjunction with other interventions not necessarily dedicated to downhole battery issues. Thus, the costs in terms of time or resources dedicated to battery replenishment may be kept to a minimum.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. Furthermore, the foregoing description should not be read as pertaining only to the precise structures described and shown in the accompanying drawings, but rather should be read as consistent with and as support for the following claims, which are to have their fullest and fairest scope.

I claim:

1. A replenishable battery for substantially permanent placement at a downhole location in a well, the battery comprising:
a refillable anode fluid tank;
a refillable cathode fluid tank; and
a reaction chamber in fluid communication with said tanks for generating power for a downhole application in the well.

2. The battery of claim 1 further comprising at least one internal pump for directing anode and cathode fluids from said tanks to said chamber at a given rate.

3. The battery of claim 2 further comprising return lines for directing the fluids from said chamber at the given rate upon being spent on the generating.

4. The battery of claim 1 wherein said reaction chamber comprises a plurality of voids isolated by a plurality of membranes to alternatingly accommodate anode and cathode fluids from said tanks for the generating.

5. The battery of claim 4 wherein the anode fluid is an anode powder suspended in electrolyte and the cathode fluid is a cathode powder suspended in electrolyte.

6. The battery of claim 5 wherein the fluids are between about 40% and about 60% powder.

7. The battery of claim 5 wherein the anode powder is a lithium-based material.

8. The battery of claim 5 wherein the cathode fluid is a lithium-based material.

9. A replenishable downhole battery assembly comprising:
downhole hardware for disposal at a location in a well; and
a battery secured to the hardware and having refillable anode and cathode fluid tanks coupled to a reaction chamber configured to provide power for a downhole application in the well.

10. The assembly of claim 9 wherein said hardware is production tubing and the application is shifting of a sleeve thereof.

11. The assembly of claim 9 further comprising a replenishment tool for interfacing a sealable outlet of said battery for refilling of the tanks.

12. The assembly of claim 11 wherein said replenishment tool comprises:
containers for accommodating unspent anode and cathode fluid for refilling of the tanks; and
a coupling for securing of the tool to a conveyance deployed from an oilfield surface adjacent the well.

13. The assembly of claim 12 wherein the conveyance is selected from a group consisting of coiled tubing, wireline and slicklinc.

14. A method of replenishing a downhole battery, the method comprising:
delivering a battery replenishment tool to a location of a battery in a well;
replacing anode fluid in the battery with the tool; and
replacing cathode fluid in the battery with the tool.

15. The method of claim 14 wherein said replacing of the fluids takes place in less than about an hour.

16. The method of claim 14 further comprising performing an application in the well with power supplied by the battery.

17. The method of claim 16 wherein the application utilizes a device selected from a group consisting of a valve, an actuator, a sensor, and an electrical submersible pump.

18. The method of claim 14 wherein said delivering comprises:
shifting open a seal at a sealable outlet of the battery with the tool; and
securing a wet-mate coupling of the tool to the sealable outlet.

19. The method of claim 14 wherein said replacing of the fluids comprises
circulating unspent anode and cathode fluid into the battery from the tool; and
circulating spent anode and cathode fluids out of the battery.

20. The method of claim 19 wherein said circulating of the spent fluids further comprises recovering the spent fluids to the tool for removal from the well.
